(19) United States
(12) Patent Application Publication
(10) Pub. No.: US 2011/0287118 A1
(43) Pub. Date: Nov. 24, 2011

(54) OPHTHALMIC LENS MOLD TREATMENT

(76) Inventors: Peyton L. Hopson, Jacksonville, FL (US); Stephen C. Pegram, Fruit Cove, FL (US); Nitin Nitin, Helotoes, TX (US); Heather S. Hanson, San Antonio, TX (US); Michael Rubal, Lytle, TX (US); Douglas P. Hanson, San Antonio, TX (US)

(21) Appl. No.: 13/071,929

(22) Filed: Mar. 25, 2011

Related U.S. Application Data
(60) Provisional application No. 61/317,334, filed on Mar. 25, 2010.

(51) Int. Cl. B28B 7/38

(52) U.S. Cl. 425/98

(57) ABSTRACT

An apparatus and method for treating an ophthalmic lens mold part. The treatment includes formation of ketones on a lens forming surface of the mold part. In some embodiments, the treatment includes exposure of the surface of the lens forming surface to ozone.

### CROSS REFERENCE TO RELATED APPLICATION

This application claims priority to and the benefit of U.S. Provisional Patent Application No. 61/317,334, filed Mar. 25, 2010, which is hereby incorporated by reference in its entirety.

### FIELD

The present invention relates to ophthalmic lens molds and, more particularly, to treatment of an ophthalmic lens mold part prior to contact of a Reactive Mixture with the mold part. The invention also relates to methods and apparatus used for treating the ophthalmic lens molds.

### BACKGROUND INFORMATION

It is well known that contact lenses can be used to improve vision. Various contact lenses have been commercially produced for many years. Early designs of contact lenses were fashioned from hard materials. Although hard material lenses are still currently used in some applications, they are not suitable for all patients due to issues with comfort and relatively low permeability to oxygen. Later developments in the field gave rise to soft contact lenses, based upon hydrogels.

Currently, silicon hydrogel contact lenses are widely accepted. Soft silicon hydrogel lenses are often more comfortable to wear than contact lenses made of hard materials. Soft contact lenses can be manufactured by forming a lens in a multi-part mold wherein the combined parts form a topography consistent with the desired final lens.

Multi-part molds used to fashion hydrogels into a useful article, such as an ophthalmic lens, can include for example, a first mold portion with a convex surface that corresponds with a back curve of an ophthalmic lens and a second mold portion with a concave surface that corresponds with a front curve of the ophthalmic lens. To prepare a lens, a Reactive Mixture is deposited between the concave and convex surfaces of the mold portions and subsequently cured. The Reactive Mixture may be cured, for example by exposure to either, or both of, heat and light. The cured hydrogel forms a lens according to the dimensions of the mold portions in contact with the uncured hydrogel lens formulation. It is therefore important that the Reactive Mixture contiguously wet the lens mold part without gaps or holes.

Following cure, traditional practice dictates that the mold portions are separated and the lens remains adhered to one of the mold portions. A release process detaches the lens from the remaining mold part. It has been known to treat a mold part with a corona process prior to deposition of the uncured lens formulation; however such treatment typically causes unacceptably high levels of lens material adherence to the treated mold part. Such high levels of adherence ultimately results in high levels of lens damage to during attempts to remove the lens from the mold part.

Accordingly, it would be advantageous to deploy methods and apparatus that facilitate wetting of the lens mold part following deposition of the Reactive Mixture and yet not bind the cured polymer to the mold part to the extent that the lens is damaged during removal.

### BRIEF DESCRIPTION OF THE DRAWINGS

The present invention is disclosed with reference to the accompanying drawings, wherein:

FIG. 1 illustrates a mold system according to some embodiments of the present invention.

FIG. 2 illustrates a back curve mold part according to some embodiments of the present invention.

FIG. 3 illustrates apparatus included in some embodiments of the present invention.

FIG. 4 illustrates delivery tubes for ozone according to some exemplary embodiments of the present invention.

FIG. 5 illustrates network of delivery tubes for ozone according to some exemplary embodiments of the present invention.

FIG. 6 illustrates an exemplary ozone generator secured to an overhead mount.

FIG. 7 illustrates a flowchart according to some exemplary embodiments of the present invention.

### DETAILED DESCRIPTION

The present invention includes molds useful for forming an ophthalmic lens and methods of treating a plastic mold part used to form an ophthalmic lens. According to the present invention, at least one part of a multi-part mold system that is used in the manufacture of an ophthalmic lens, is exposed to an atmosphere, such as ozone, prior to deposition of a Reactive Mixture into the mold part, wherein such exposure increases the hydrophilic properties of the mold part surface in a controllable manner. Some specific embodiments include the formation of a layer of ketones on the mold part, wherein the layer of ketones facilitates increased adherence of a lens formed in contact with the mold part, however, according to the present invention, the increased adherence is limited to a level such that an associated lens remains removable from the mold part via hydration and gentle swabbing of the lens, without damage to the lens. In addition, in some embodiments, the present invention includes a plastic mold part with a surface modified to include a layer of ketones.

According to some embodiments of the present invention at least a portion of a mold part is exposed to an ozone enriched atmosphere. Exposure of the portion of the surface of the mold part to ozone is maintained for a sufficient time and at a sufficient concentration of oxygen to modify the portion of the surface of the mold part exposed to the ozone. Modification may include, for example the formation of ketones along the portion of the surface exposed to the ozone.

Exposure to the ozone containing atmosphere modifies at least a portion of the surface of the mold part and such modification increases the wettability of the modified surface of the mold part. Increased wettability generally allows for better distribution of the Reactive Mixture along a molding surface of the mold part prior to polymerization of the Reactive Mixture.

In another aspect, the ozone containing atmosphere modifies at least a portion of the surface of the mold part to increase the surface energy of the surface of the mold part.

Molds

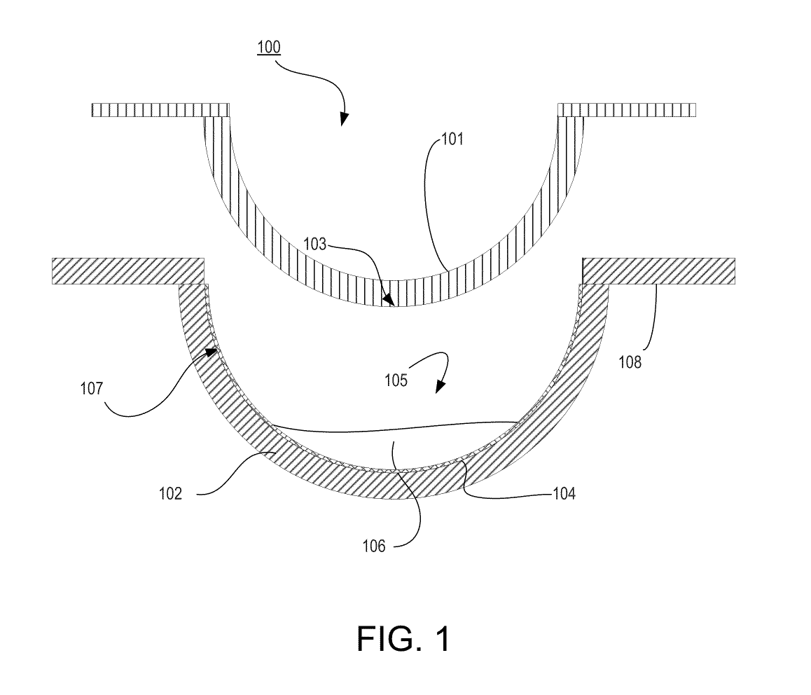

Referring now to FIG. 1, a diagram of an exemplary mold for an ophthalmic lens is illustrated. As used herein, the terms “mold” and “mold assembly” refer to a form 100 having a cavity 105 into which a lens forming mixture (“Reactive Mixture”) can be dispensed such that upon reaction or cure of the Reactive Mixture, an ophthalmic lens (not illustrated) of a desired shape is produced. The molds and mold assemblies 100 of this invention are made up of more than one “mold parts” or “mold pieces” 101-102. The mold parts 101-102 can be brought together such that a cavity 105 is formed between the mold parts 101-102 in which a lens can be formed. This combination of mold parts 101-102 is preferably temporary. Upon formation of the lens, the mold parts 101-102 can again be separated for removal of the lens.

At least one mold part 101-102 has at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102.

Thus, for example, in a preferred embodiment a mold assembly 100 is formed from two parts 101-102, a female concave piece (front piece) 102 and a male convex piece (back piece) 101 with a cavity formed between them. The portion of the concave surface 104 which makes contact with lens forming mixture has the curvature of the front curve of an ophthalmic lens to be produced in the mold assembly 100 and is sufficiently smooth and formed such that the surface of a ophthalmic lens formed by polymerization of the lens forming mixture which is in contact with the concave surface 104 is optically acceptable.

The back mold piece 101 has a central curved section with a convex surface 103, wherein the portion of the convex surface 103 in contact with the lens forming mixture has the curvature of the back curve of a ophthalmic lens to be produced in the mold assembly 100 and is sufficiently smooth and formed such that the surface of a ophthalmic lens formed by reaction or cure of the lens forming mixture in contact with the back surface 103 is optically acceptable. Accordingly, the inner concave surface 104 of the front mold half 102 defines the outer surface of the ophthalmic lens, while the outer convex surface 103 of the base mold half 101 defines the inner surface of the ophthalmic lens.

According to the present invention, at least one mold part 101-102 is exposed to a ketone forming atmosphere such as an atmosphere that is ozone enriched. In some non-limiting examples, and as illustrated in FIG. 1, a concave lens forming surface portion 104, is treated via exposure to an atmosphere including ozone to create a treated lens forming surface 107. The treated lens forming surface 107 will include an increased surface energy. The increased surface energy has the effect that a lens formed along the treated surface will adhere more strongly. However, unlike other known treatments, such as corona treatment, the exposure of a lens forming surface 103-104 to ozone does not result in damage to an increase in damage to a lens during removal of the lens from a treated lens forming surface 107.

As discussed above, a monomer or other Reactive Mixture 106 is deposited into a lens cavity 105 and comes into contact with a treated lens forming surface 107. Generally, the mold parts 101-102 are assembled to cause the Reactive Mixture 106 to form a shape of a desired lens and the Reactive mixture is exposed to actinic radiation causing the Reactive Mixture to polymerize in the shape of a contact lens. During polymerization, an adhesive force is generated between a formed lens and the mold parts 101-102. According to the present invention, the adhesive force will be greater between the mold part with an ozone treated surface 102. The greater adhesive force causes a formed lens to remain with the mold part 102 including a treated lens forming surface 107.

In another aspect, although this discussion is focused on a treated lens forming surface 107, some embodiments of the present invention may include a surface of a mold part that contacts a ring of excess lens material, sometimes referred to as a HEMA ring.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

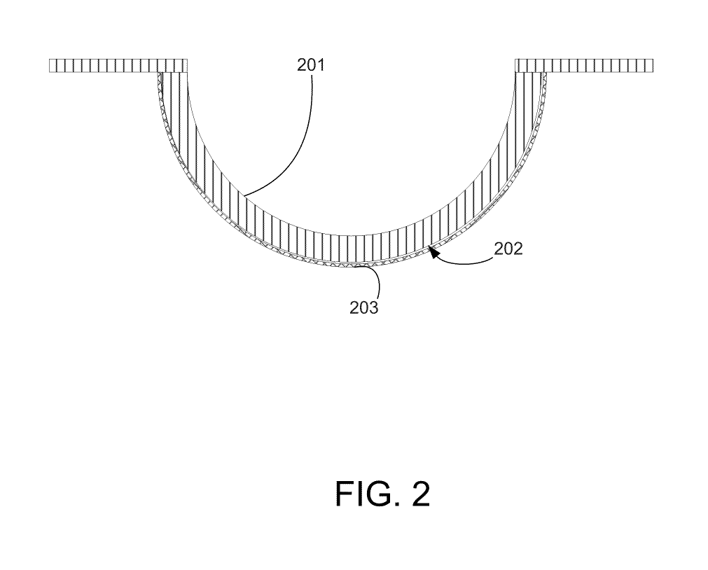

Referring now to FIG. 2, in other non-limiting examples, a mold part 201 includes a convex lens forming surface 202, which, according to the present invention is exposed to a ketone forming atmosphere. The ketone forming atmosphere may include, for example ozone. Following exposure a ketone layer is formed on the lens forming surface 202 which increases the surface tension of the lens forming surface 202.

In some preferred embodiments, molds 100 can include two mold parts 101-102 as described above, wherein one or both of the front curve part 102 and the back curve part 101 of the mold 100 includes a thermoplastic polyolefin compound.

In some embodiments the thermoplastic resin can include an alicyclic polymer which refers to compounds having at least one saturated carbocyclic ring therein. The saturated carbocyclic rings may be substituted with one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents are selected from one or more members of the group consisting of halogen, hydroxyl, C₁₋₁₀alkoxycarbonyl, C₁₋₁₀alkoxy, cyano, amido, imido, and silyl. Examples of alicyclic polymers include but are not limited to polymerizable cyclobutanes, cyclopentanes, cyclohexanes, cycloheptanes, cyclooctanes, biscyclobutanes, biscyclopentanes, biscyclohexanes, biscycloheptanes, biscyclooctanes, and norbornanes. It is preferred that the at least two alicyclic polymers be polymerized by ring opening metathesis followed by hydrogenation. Since co-polymers are costly, it is preferable that the molds made from these co-polymers may be used several times to prepare lenses instead of once which is typical. For the preferred molds of the invention, they may be used more than once to produce lenses.

More particularly, examples of alicyclic polymer containing saturated carbocyclic rings include but are not limited to the following structures:

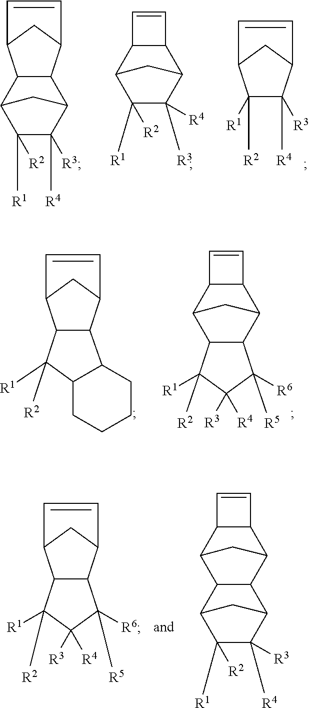

wherein R¹-⁶ are independently selected from one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents selected from one or more members of the group consisting of halogen, hydroxyl, C₁₋₁₀alkoxycarbonyl, C₁₋₁₀alkoxy, cyano, amido, imido and silyl. Further two or more of R¹⁻⁶ may be taken together to form an unsaturated bond, a carbocyclic ring, a carbocyclic ring containing one or more unsaturated bonds, or an aromatic ring. The preferred R¹⁻⁶ is selected from the group consisting of C₁₋₁₀alkyl and substituted C₁₋₁₀alkyl where the substituents are selected from the group consisting of halogen, hydroxyl, C₁₋₁₀alkoxycarbonyl, C₁₋₁₀alkoxy, cyano, amido, imido and silyl.

The alicyclic co-polymers consist of at least two different alicyclic polymers. The preferred alicyclic co-polymers contain two or three different alicyclic polymers, selected from the group consisting of:

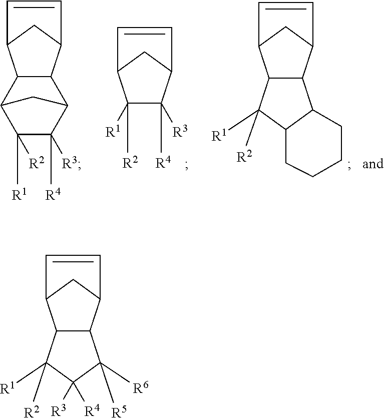

The particularly preferred alicyclic co-polymer contains two different alicyclic monomers where the generic structure of the saturated carbocyclic rings of the alicyclic polymers are of the formula

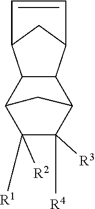

and R¹-R⁴ are C₁₋₁₀alkyl.

A preferred alicyclic co-polymer contains two different alicyclic polymers and is sold by Zeon Chemicals L.P. under the trade name ZEONOR and ZEONEX. There are several different grades of ZEONOR and ZEONEX. Various grades may have glass transition temperatures ranging from 100° C. to 160° C. A specifically preferred material is ZEONOR 1060R.

Other mold materials that may combine with one or more additives to form an ophthalmic lens mold include, for example, Zieglar-Natta polypropylene resins (sometimes referred to as znPP). On exemplary Zieglar-Natta polypropylene resin is available under the name PP 9544 MED. PP 9544 MED is a clarified random copolymer for clean molding as per FDA regulation 21 CFR (c) 3.2 made available by ExxonMobile Chemical Company. PP 9544 MED is a random copolymer (znPP) with ethylene group (hereinafter 9544 MED). Other exemplary Zieglar-Natta polypropylene resins include: Atofina Polypropylene 3761 and Atofina Polypropylene 3620WZ.

Still further, in some embodiments, the molds of the invention may contain polymers such as polypropylene, polyethylene, polystyrene, polymethyl methacrylate, modified polyolefins containing an alicyclic moiety in the main chain and cyclic polyolefins. This blend can be used on either or both mold halves, where it is preferred that this blend is used on the back curve and the front curve consists of the alicyclic co-polymers.

In some preferred methods of making molds 100 according to the present invention, injection molding is utilized according to known techniques, however, embodiments can also include molds fashioned by other techniques including, for example: lathing, diamond turning, or laser cutting.

Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “Reactive Mixture,” sometimes referred to a as a “lens forming mixture” refers to a mixture of materials that can react, or be cured, to form an ophthalmic lens. Such a mixture can include polymerizable components (monomers), additives such as UV blockers and tints, photoinitiators or catalysts, and other additives one might desire in an ophthalmic lens such as a contact or intraocular lens.

In some embodiments, a preferred lens type can include a lens that includes a silicone containing component. A “silicone-containing component” is one that contains at least one [—Si—O—] unit in a monomer, macromer or prepolymer. Preferably, the total Si and attached O are present in the silicone-containing component in an amount greater than about 20 weight percent, and more preferably greater than 30 weight percent of the total molecular weight of the silicone-containing component. Useful silicone-containing components preferably comprise polymerizable functional groups such as acrylate, methacrylate, acrylamide, methacrylamide, vinyl, N-vinyl lactam, N-vinylamide, and styryl functional groups.

Suitable silicone containing components include compounds of Formula I

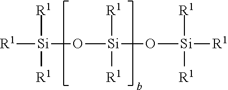

where

R¹ is independently selected from monovalent reactive groups, monovalent alkyl groups, or monovalent aryl groups, any of the foregoing which may further comprise functionality selected from hydroxy, amino, oxa, carboxy, alkyl carboxy, alkoxy, amido, carbamate, carbonate, halogen or combinations thereof; and monovalent siloxane chains comprising 1-100 Si—O repeat units which may further comprise functionality selected from alkyl, hydroxy, amino, oxa, carboxy, alkyl carboxy, alkoxy, amido, carbamate, halogen or combinations thereof;

where b=0 to 500, where it is understood that when b is other than 0, b is a distribution having a mode equal to a stated value;

wherein at least one R¹ comprises a monovalent reactive group, and in some embodiments between one and 3 R¹ comprise monovalent reactive groups.

As used herein “monovalent reactive groups” are groups that can undergo free radical and/or cationic polymerization. Non-limiting examples of free radical reactive groups include (meth)acrylates, styryls, vinyls, vinyl ethers, C₁₋₆alkyl(meth)acrylates, (meth)acrylamides, C₁₋₆alkyl(meth)acrylamides, N-vinyllactams, N-vinylamides, C₂₋₁₂alkenyls, C₂₋₁₂alkenylphenyls, C₂₋₁₂alkenylnaphthyls, C₂₋₆alkenylphenylC₁₋₆alkyls, O-vinylcarbamates and O-vinylcarbonates. Non-limiting examples of cationic reactive groups include vinyl ethers or epoxide groups and mixtures thereof. In one embodiment the free radical reactive groups comprises (meth)acrylate, acryloxy, (meth)acrylamide, and mixtures thereof.

Suitable monovalent alkyl and aryl groups include unsubstituted monovalent C₁ to C₁₆alkyl groups, C₆-C₁₄ aryl groups, such as substituted and unsubstituted methyl, ethyl, propyl, butyl, 2-hydroxypropyl, propoxypropyl, polyethyleneoxypropyl, combinations thereof and the like.

In one embodiment b is zero, one R¹ is a monovalent reactive group, and at least 3 R¹ are selected from monovalent alkyl groups having one to 16 carbon atoms, and in another embodiment from monovalent alkyl groups having one to 6 carbon atoms. Non-limiting examples of silicone components of this embodiment include 2-methyl-,2-hydroxy-3-[3-[1,3,3,3-tetramethyl-1-[(trimethylsilyl)oxy]disiloxanyl]propoxy]propyl ester (“SiGMA”),
2-hydroxy-3-methacryloxypropyloxypropyl-tris(trimethylsiloxy)silane,
3-methacryloxypropyltris(trimethylsiloxy)silane (“TRIS”),
3-methacryloxypropylbis(trimethylsiloxy)methylsilane and
3-methacryloxypropylpentamethyl disiloxane.

In another embodiment, b is 2 to 20, 3 to 15 or in some embodiments 3 to 10; at least one terminal R¹ comprises a monovalent reactive group and the remaining R¹ are selected from monovalent alkyl groups having 1 to 16 carbon atoms, and in another embodiment from monovalent alkyl groups having 1 to 6 carbon atoms. In yet another embodiment, b is 3 to 15, one terminal R¹ comprises a monovalent reactive group, the other terminal R¹ comprises a monovalent alkyl group having 1 to 6 carbon atoms and the remaining R¹ comprise monovalent alkyl group having 1 to 3 carbon atoms. Non-limiting examples of silicone components of this embodiment include (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), (“mPDMS”).

In another embodiment b is 5 to 400 or from 10 to 300, both terminal R¹ comprise monovalent reactive groups and the remaining R¹ are independently selected from monovalent alkyl groups having 1 to 18 carbon atoms which may have ether linkages between carbon atoms and may further comprise halogen.

In one embodiment, where a silicone hydrogel lens is desired, the lens of the present invention will be made from a reactive mixture comprising at least about 20 and preferably between about 20 and 70% wt silicone containing components based on total weight of reactive monomer components from which the polymer is made.

In another embodiment, one to four R¹ comprises a vinyl carbonate or carbamate of the formula:

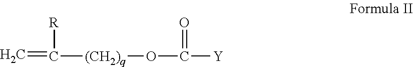

wherein: Y denotes O—, S— or NH—;

R denotes hydrogen or methyl; d is 1, 2, 3 or 4; and q is 0 or 1.

The silicone-containing vinyl carbonate or vinyl carbamate monomers specifically include: 1,3-bis[4-(vinyloxycarbonyloxy)but-1-yl]tetramethyl-disiloxane; 3-(vinyloxycarbonylthio)propyl-[tris(trimethylsiloxy)silane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate, and

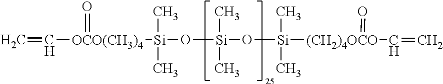

Where biomedical devices with modulus below about 200 are desired, only one R¹ shall comprise a monovalent reactive group and no more than two of the remaining R¹ groups will comprise monovalent siloxane groups.

Another class of silicone-containing components includes polyurethane macromers of the following formulae:

(*D*A*D*G)_{α}*D*D*E¹;

E(*D*G*D*A)_{α}*D*G*D*E¹ or;

E(*D*A*D*G)_{α}*D*A*D*E¹ Formulae IV-VI

wherein:

D denotes an alkyl diradical, an alkyl cycloalkyl diradical, a cycloalkyl diradical, an aryl diradical or an alkylaryl diradical having 6 to 30 carbon atoms,

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

a. denotes a urethane or ureido linkage;
_{α} is at least 1;

A denotes a divalent polymeric radical of formula:

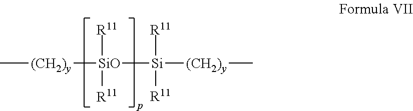

R¹¹ independently denotes an alkyl or fluoro-substituted alkyl group having 1 to 10 carbon atoms which may contain ether linkages between carbon atoms; y is at least 1; and p provides a moiety weight of 400 to 10,000; each of E and E¹ independently denotes a polymerizable unsaturated organic radical represented by formula:

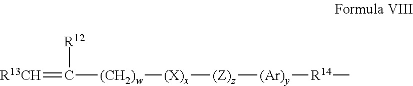

wherein: R¹² is hydrogen or methyl; R¹³ is hydrogen, an alkyl radical having 1 to 6 carbon atoms, or a —CO—Y—R¹⁵ radical wherein Y is —O—, Y—S— or —NH—; R¹⁴ is a divalent radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.

A preferred silicone-containing component is a polyurethane macromer represented by the following formula:

Other silicone containing components suitable for use in this invention include macromers containing polysiloxane, polyalkylene ether, diisocyanate, polyfluorinated hydrocarbon, polyfluorinated ether and polysaccharide groups; polysiloxanes with a polar fluorinated graft or side group having a hydrogen atom attached to a terminal difluoro-substituted carbon atom; hydrophilic siloxanyl methacrylates containing ether and siloxanyl linkanges and crosslinkable monomers containing polyether and polysiloxanyl groups. Any of the foregoing polysiloxanes can also be used as the silicone containing component in this invention.

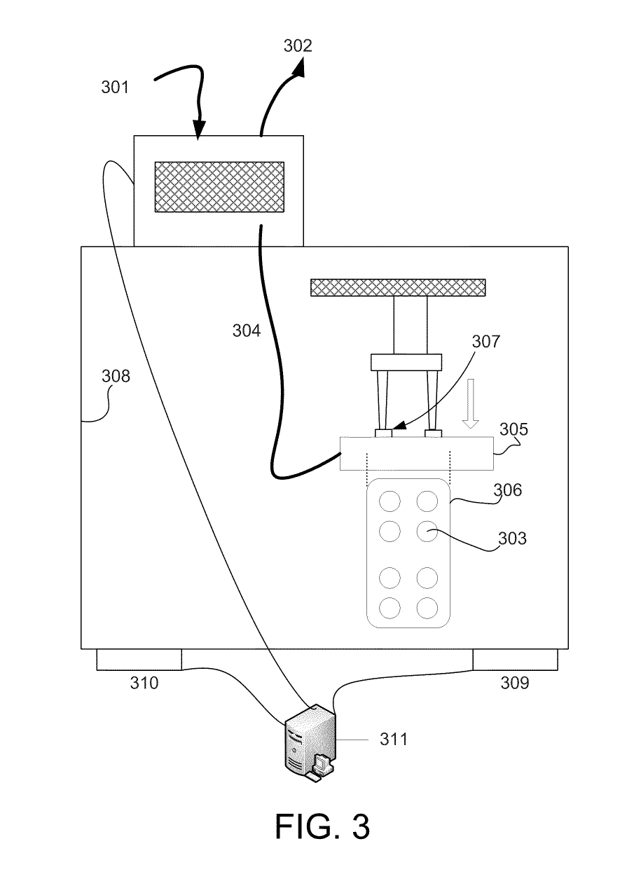

Referring now to FIG. 3, a block diagram illustrates various aspects of the present invention. Generally, preferred embodiments include one or more mold parts 303 supported by a pallet or other fixture 306 provided mechanical support. A hood 305 or other atmosphere containing apparatus contains an atmosphere proximate to mold parts 303 supported by the fixture 306. According to the present invention, an atmospheric component is added to the atmosphere contained beneath the hood 305. One preferred atmospheric component is ozone.

In some embodiments, ozone may be supplied by an ozone generator 301 that is in gaseous communication with the hood 305. Gaseous communication may be achieved via a flexible tube 304, or other piping. In some embodiments, a dedicated supply fixture 307 supplies an atmospheric gas, with the atmospheric component such as ozone, to each respective mold part 303 supported by the fixture 306. An ozone generator typically generates a supply of ozone via electrical arc or plasma discharge. The generated ozone is then transported to an atmosphere contained within a hood 305. A vent 302 may appropriately dispose of any atmospheric components not transported to the hood 305.

According to the present invention, any plasma or arc is maintained in a position sufficiently distal from the mold part 303 such that the surface properties of the mold part 303 are not affected by an the electrical arc or plasma discharge that may take place within the ozone generator other than a secondary affect of a gas or other atmospheric component generated by such electrical arc and or plasma discharge.

In another aspect of the present invention, because ozone may be adverse to an operator exposed to emissions from a manufacturing machine, in some embodiments, an atmospheric enclosure 308 may contain an atmosphere surrounding the mold part 303 and the hood 305. In addition, some additional embodiments may include sensors 309-310 to monitor an atmosphere external to the atmospheric enclosure 308. Some specific embodiments include ozone monitors 309-310 to monitor for ozone which may escape from the enclosure 308. The monitors may include an alarm, such as an audio alarm ascertainable by a human ear. Embodiments may also include an alarm in logical communication with a controller 311. The controller 311 may also be in logical communication with the ozone generator 301 to cease production of ozone. Additional measures may include dissipation of any ozone concentrations above a desired level external to the enclosure 308.

In some embodiments, sensors 309-310 monitor atmospheric conditions external to the enclosure 308. Monitoring may be used to detect levels of atmospheric components that exceed predetermined thresholds. By way of non-limiting example, sensors 309-310 may be used to monitor the presence of ozone external to the enclosure 308 at a level that exceeds a predetermined level. The sensors may be in one or both of electrical and logical communication with an alarm. Alarms may include an audible alarm perceptible to human ears. Alarms may also include a visual indicator, such as a light.

In some embodiments, the sensors 309-310 may be in logical communication with the controller 311. In the event of the detection by the sensors 309-310 of one or more atmospheric conditions that exceed one or more predetermined thresholds, the controller 311 may also be in logical communication with the ozone generator 301 or other atmospheric component device, and adjust the output of the ozone generator 301 to cease production of the ozone until the conditions with unacceptable levels of ozone are rectified.

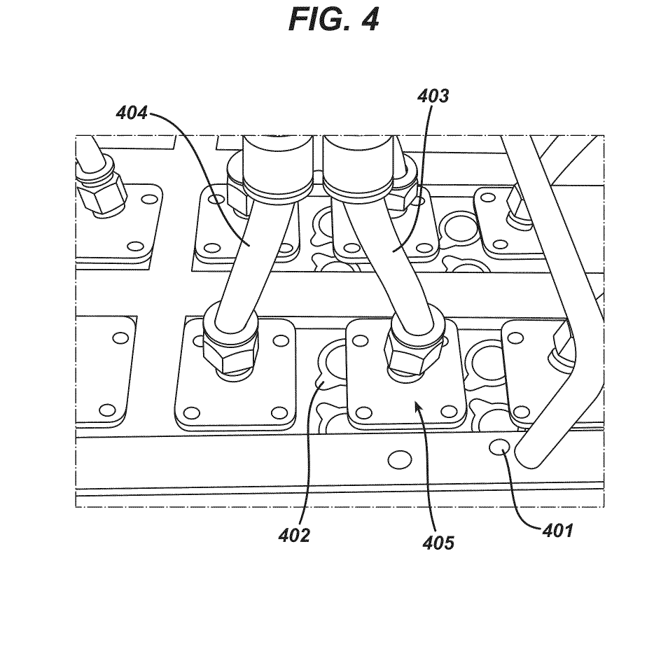

Referring now to FIG. 4, an example of routing of ozone to a mold part is illustrated. A pallet 401 or other support structure may hold multiple mold parts 402 in place while a tube 403-404, manifold or other gaseous communication device conveys ozone to a hood 404 or manifold proximate to the mold part 402. As discussed above, the ozone may be provided by an ozone generator and piped via the tubes to a location proximate to the mold part.

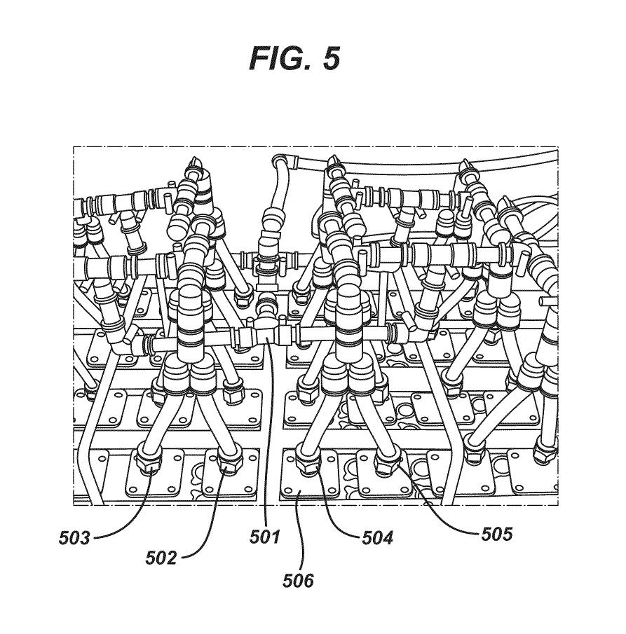

Referring now to FIG. 5, a network of tubing 501 is illustrated with multiple egress points 502-505. As illustrated, each egress point is in gaseous communication with a hood 506 or manifold.

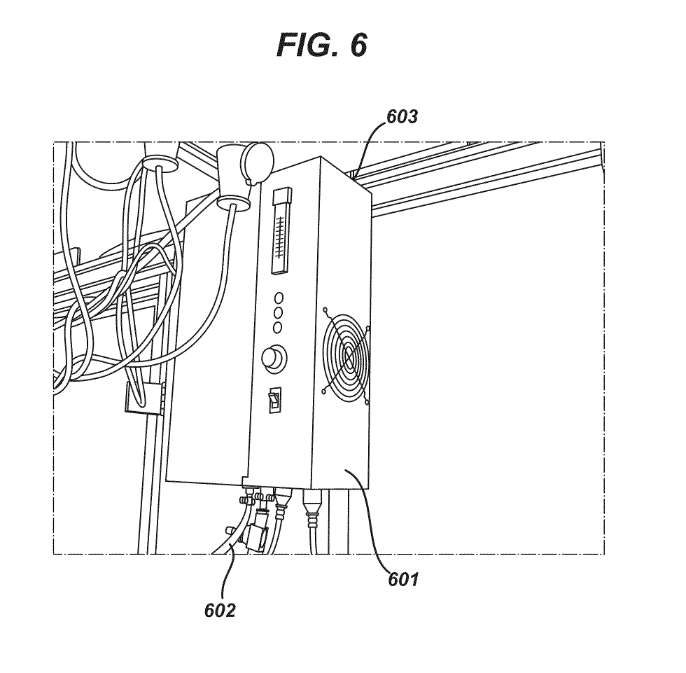

At FIG. 6, an ozone generator 601 is mounted above pallets of mold parts. A tube 602 or piping or other vehicle for gaseous communication transfers ozone generated by the ozone generator 601 to the mold parts.

Methods

The following method steps are provided as examples of processes that may be implemented according to some aspects of the present invention. It should be understood that the order in which the method steps are presented is not meant to be limiting and other orders may be used to implement the invention. In addition, not all of the steps are required to implement the present invention and additional steps may be included in various embodiments of the present invention.

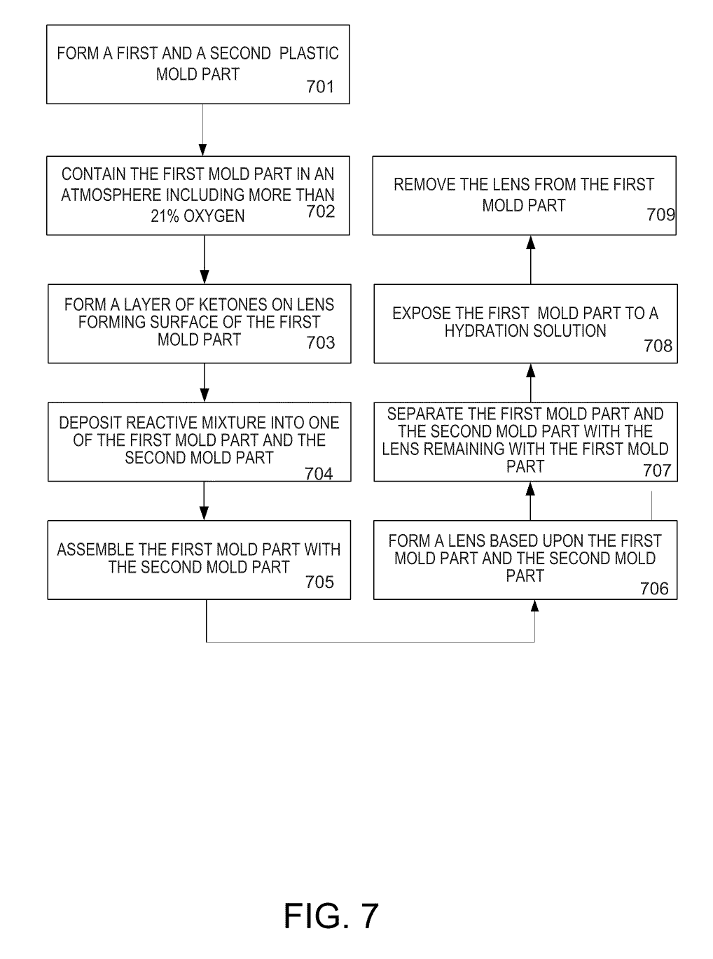

Referring now to FIG. 7, a flowchart illustrates exemplary steps that may be used to implement the present invention.

At 701, the plasticized resin is injected into an injection mold shaped in a fashion suitable for creating an ophthalmic lens mold part to form one or both of a first and second mold part. Other methods of forming a mold part, such as lathing or freeform may also be utilized in alternative embodiments. Injection molding techniques are well known and preparation typically involves heating resin pellets beyond a melting point.

At 702, the a first mold part is contained in an atmosphere of more than 21% oxygen, via the addition of ozone to the atmosphere.

At 703, a layer of ketones is formed on a lens surface of the first mold part. At 704, an uncured Reactive Mixture is deposited into at least one of the first and second mold part. At 705 the first mold part is assembled with the second mold part. At 706 the Reactive Mixture is cured or polymerized to form a lens based upon the first and second mold part.

As used herein, the term “uncured” refers to the physical state of a lens formulation prior to final curing of the lens formulation to make the lens. In some embodiments, lens formulations can contain mixtures of monomers which are cured only once. Other embodiments can include partially cured lens formulations that contain monomers, partially cured monomers, macromers and other components.

As used herein, the phrase “curing under suitable conditions” refers to any suitable method of curing lens formulations, such as using light, heat, and the appropriate catalysts to produce a cured lens. Light can include, in some specific examples, ultra violet light. Curing can include any exposure of the lens forming mixture to an actinic radiation sufficient to case the lens forming mixture to polymerize.

At 707, the first mold part is separated from the second mold part, wherein the lens remains with the first mold part. At 708, the first mold part is exposed to a hydration solution, wherein at 709 the lens may be removed from the mold part via exposure to the hydration solution or via gentle swabbing with a cotton swab and without damage to the lens.

### CONCLUSION

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. Apparatus for treating an ophthalmic lens mold part, the apparatus comprising:
a source of an atmospheric component, wherein the atmospheric component comprises a catalyst for controlled ketone formation on a surface of the ophthalmic lens mold part such that the formed ketones are sufficient to increase surface energy of the surface of the ophthalmic lens mold part and limit the adhesion of ophthalmic lens to the ophthalmic lens mold part such that the lens may be released from the mold part via hydration;
a fixture for supporting one or more ophthalmic lens mold parts;
a hood for concentrating an atmospheric component proximate to the one or more lens mold parts supported by the fixture;
an atmospheric component conduit in gaseous communication with a supply unit of the atmospheric component and the hood; and
a source of a differential in atmospheric pressure sufficient to convey the atmospheric component from the source to the hood.

2. The apparatus of claim 1 wherein the atmospheric component comprises ozone.

3. The apparatus of claim 2 wherein the atmospheric component comprises a sufficient amount of ozone such that an atmosphere within the hood comprises more than 21% oxygen.

4. The apparatus of claim 2 wherein the atmosphere within the hood comprises more than 21% oxygen and nitrogen.

5. The apparatus of claim 2 wherein the source of an atmospheric component comprises an ozone generator.

6. The apparatus of claim 2 additionally comprising an enclosure containing an atmosphere proximate to the hood and the fixture.

7. The apparatus of claim 6 additionally comprising an ozone monitor external to the enclosure and an alarm in logical communication with the ozone monitor and responsive to a signal from the ozone monitor indicating that a threshold amount of detected ozone has been detected to activate an alarm.

8. The apparatus of claim 7 wherein the alarm comprises an audible signal recognizable to a human ear.

9. The apparatus of claim 2 wherein the oxygen concentration of an atmosphere beneath the hood comprises between 22% and 30% by volume.

10. The apparatus of claim 2 wherein the atmospheric component conduit comprises a flexible tube.

11. The apparatus of claim 2 wherein the atmospheric component conduit comprises a network of flexible tubes each tube providing an oxygen enriched atmospheric gas to one or more ophthalmic lens molds.
